(19) United States
(12) Patent Application Publication
(10) Pub. No.: US 2016/0239224 A1
(43) Pub. Date: Aug. 18, 2016

(54) METHOD AND SYSTEM FOR TRANSFERRING DATA OVER A PLURALITY OF CONTROL LINES

(71) Applicant: SAMSUNG ELECTRONICS CO., LTD., SUWON-SI (KR)

(72) Inventors: M.P. BHAVITH, BANGALORE (IN); HEE-CHANG CHO, BANGALORE (IN); SONY M. PAPPAN, BANGALORE (IN)

(21) Appl. No.: 14/992,039

(22) Filed: Jan. 11, 2016

(30) Foreign Application Priority Data
Feb. 13, 2015 (IN) 723/CHE/2015

(51) Int. Cl. G06F 3/06; G06F 13/42; G06F 13/38

(52) U.S. Cl. CPC G06F 3/0613; G06F 3/0659; G06F 3/067; G06F 13/385; G06F 13/4282; G06F 3/065; G06F 3/0619

(57) ABSTRACT

A method and system for transferring data over a plurality of control lines includes receiving, by a first device, a command from a host device to transfer the data from the first device to a second device; and independently transmitting, by the first device, the data to the second device based on the command, where the data is independently transferred using the plurality of control lines. The method further includes transferring of the data from the first device to the second device performed independent of the host device; and sending, by the first device, a data transfer completion message to the host device.

### CROSS-REFERENCE TO RELATED APPLICATIONS

A claim of priority under 35 U.S.C. §119 is made to Indian Patent Application No. 723/CHE/2015 filed on Feb. 13, 2015, the entire contents of which are hereby incorporated by reference.

### BACKGROUND

The inventive concept herein relates to transfer of data, and more particularly to transferring data from a first device to a second device over a plurality of control lines.

Generally, a host device may be connected to different devices using a plurality of data, address, and control lines referred to as a “bus” that typically complies with well-known standards. The devices connected to the bus may include memory or storage devices, communication devices, sensing devices, or the like, and the devices can be either fixed or removable. In most situations, some or all of the control lines of the bus are shared amongst any or all of the devices that are connected to the bus. Typically, a master-slave bus protocol is adopted for the bus. The master-slave is a model for a communication protocol in which one device or process has unidirectional control over one or more other devices. In conventional systems, once the master-slave relationship between the devices or processes is established, the direction of control is always from the master device to the slave devices.

In traditional systems, the data is typically passed over the common bus from a source slave storage device to a host device or a host controller or other intermediary, where the data is temporarily cached before being transferred by the host device over the common bus and targeted towards a destination slave storage device where the data is then read from the common bus and stored.

For example, in system 100 as shown in FIG. 1, the host device 102, using controller unit 112 and device driver 114, may initiate the transfer of data from a device-1 (logical unit or partition) 104 to a device-2 106, responsive to an application 116 (copy/move data from partition P to Q). The data from the device-1 104 is transferred over the bus (not shown) to the host device 102, where the data is read at the host device 102 (as indicated at 118) and temporarily cached before being transferred by the host device 102. The host device 102 transfers the cached data to the device-2 106 over the bus (as indicated at 120), and the data is read from the bus and stored by the device-2 106 as shown in the FIG. 1. In another example, the data from device-1 104 may be read by a host controller/host bus adapter and then sent to device-2 106 over the bus in which the host CPU is not part of the data movement operation. Although, the traditional systems work well, it is desirable to reduce the host resources required for transferring data between the devices, as well as to reduce the bus utilization and memory requirements of the host device or other temporary storage devices.

Thus, there remains a need of a robust method and system to transfer data from one device to another device without intervention of the host device.

The above information is presented as background information only to help the reader to understand the inventive concept. Applicants have made no determination and make no assertion as to whether any of the above might be applicable as Prior Art with regard to the present application.

### SUMMARY

Embodiments of the inventive concept provide a method and system for transferring data over a plurality of address/data/control lines without intervention of a host device, and to provide a mechanism to issue a command, by the host device, to initiate transfer of the data between a first device and a second device. Embodiments of the inventive concept provide a mechanism for independently transferring the data by the first device to the second device based on a command, where the data is independently transferred using the plurality of control lines without intervention of the host device. Embodiments of the inventive concept provide a mechanism for transferring the data from the first device to the second device independent of a host device, and provide a mechanism to send, by the first device, a data transfer completion message to the host device.

Embodiments of the inventive concept provide a method for transferring data over a plurality of control lines. The method includes receiving, by a first device, a command from a host device to transfer the data from the first device to a second device. The method further includes independently transferring, by the first device, the data to the second device based on the command, where the data is independently transferred using the plurality of control lines and the transfer of the data from the first device to the second device is performed independent of the host device.

Embodiments of the inventive concept provide a system for transferring data over a plurality of control lines. The system includes a first device and a second device coupled with each other and with a host device using at least one of the plurality of control lines. The system is configured to receive, by the first device, a command from the host device to transfer the data from the first device to the second device. The system is further configured to independently transfer, by the first device, the data to the second device based on the command, where the data is independently transferred using the at least one of the plurality of control lines and the transfer of the data from the first device to the second device is performed independent of the host device.

Embodiments of the inventive concept provide a method for transferring data in a system including a host device interconnected with a plurality of devices by a bus. The method includes transmitting a command from the host device to a first device from among the plurality of devices, the command comprising an instruction to transfer data from the first device to a second device from among the plurality of devices. The method further includes responsive to the command, transferring the data from the first device to the second device via the bus without transferring the data to the host device.

These and other embodiments of the inventive concept will be better appreciated and understood when considered in conjunction with the following description and the accompanying drawings. It should be understood, however, that the following description, while indicating various embodiments and specific details, are given by way of illustration only and should not be construed as limiting. Many changes and modifications may be made within the scope of the inventive concept without departing from the spirit thereof.

### BRIEF DESCRIPTION OF THE DRAWINGS

Embodiments of the inventive concept will be more clearly understood from the following description taken in conjunction with the accompanying drawings, in which:

FIG. 1 is a block diagram illustrating a prior art system transferring data from one device to another device using a host device.

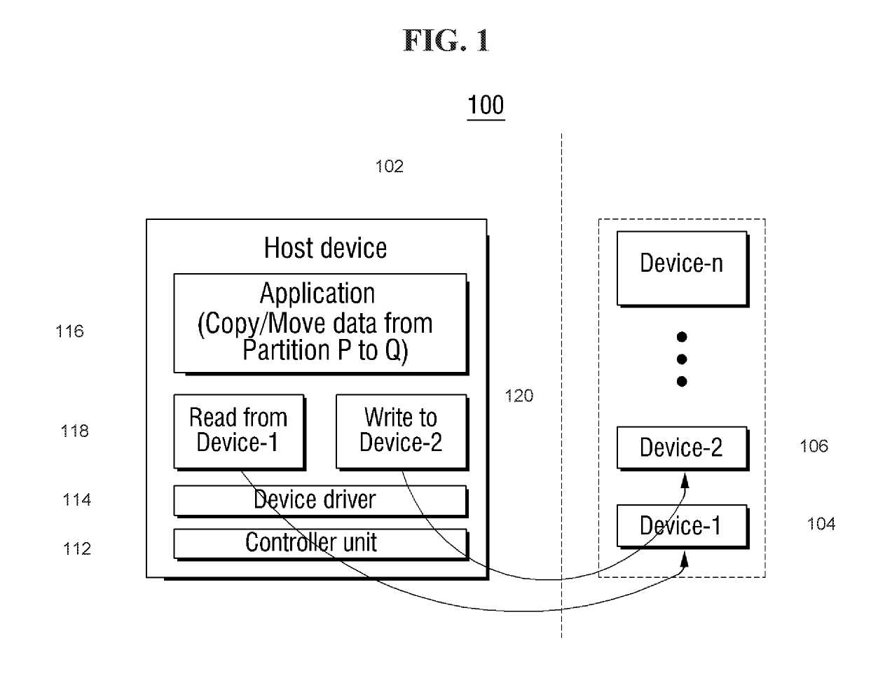

FIG. 2 is a block diagram illustrating a high level overview of a system for transferring data from a first device to a second device without intervention of a host device, according to an embodiment of the inventive concept.

FIG. 3 is a block diagram illustrating a system for transferring data from a first device to a second device arranged in a daisy chain configuration, without intervention of a host device, according to another embodiment of the inventive concept.

FIG. 4 is a block diagram illustrating various modules of the first device and/or the second device of FIGS. 2 and 3, according to an embodiment of the inventive concept.

FIG. 5 is a flow diagram illustrating a method for transferring data from a first device to a second device without intervention of a host device, according to an embodiment of the inventive concept.

FIG. 6 is a block diagram illustrating a computing environment implementing a method and system for transferring data from a first device to a second device without intervention of a host device, according to an embodiment of the inventive concept.

### DETAILED DESCRIPTION

Embodiments of the inventive concept will be described in detail with reference to the accompanying drawings. The inventive concept may however be embodied in various forms, and should not be construed as limited only to the illustrated embodiments set forth herein. Rather, these embodiments are provided as examples so that this disclosure will be thorough and complete, and will fully convey the inventive concept to one of ordinary skill in the art. In the drawings, the sizes and relative sizes of layers and regions may be exaggerated for clarity.

It will be understood that when an element or layer is referred to as being “on” or “connected to” another element or layer, it can be directly on or connected to the other element or layer, or intervening elements or layers may be present. In contrast, when an element is referred to as being “directly on” or “directly connected to” another element or layer, there are no intervening elements or layers present. Like reference numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

As used herein, the singular forms “a,” “an,” “the” and similar referents in the context of describing the inventive concept are intended to include both the singular forms as well as the plural forms, unless the context clearly indicates otherwise. It will be further understood that the terms “comprising,” “having,” “including,” and “containing”, when used in this specification, specify the presence of stated features, steps, operations, elements, components and/or groups, but do not preclude the presence or addition of one or more other features, steps, operations, elements, components and/or groups thereof.

It will be understood that, although the terms first, second, etc. may be used herein to describe various elements, the various elements should not be limited by these terms. These terms are only used to distinguish one element from another element. Thus, for example, a first element, a first component or a first section could be termed a second element, a second component or a second section without departing from the teachings of the inventive concept.

Some example embodiments of the inventive concept may be described with reference to cross-sectional views and/or plan views that are schematic illustrations of idealized embodiments and intermediate structures of some embodiments. As such, variations from the shapes of the illustrations as a result of, for example, manufacturing techniques and/or tolerances, are to be expected. Thus, such example embodiments of the inventive concept should not be construed as limited to the particular shapes illustrated herein but may include deviations in shapes that result, for example, from manufacturing.

Unless defined otherwise, all terms (including technical and scientific terms) used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and/or this specification, and will not be interpreted in an idealized or overly formal sense unless expressly so defined herein.

Also, although specific features of the inventive concept are shown in some drawings and not in others for the sake of convenience only, each feature may be combined with any or all of the other features in accordance with various embodiments of the inventive concept.

The various embodiments of the inventive concept disclosed herein relate to a method and system for transferring data over a plurality of control lines. In an embodiment of the inventive concept, the plurality of control lines forms a bus. The method may include receiving, by a first device, a command from a host device to transfer the data from the first device to a second device. In an embodiment of the inventive concept, the command may be for example a copy command or a move command, but should not be limited thereto. The command may include discontinuous fragment information of a logical object, wherein the discontinuous fragment information may include addresses of fragmented data within a storage device. The command may instruct the first device to read the data from its storage location and output the data onto the bus. Further, the method may include independently transferring, by the first device, the data to the second device based on the command, where the data is independently transferred using the plurality of control lines. The transfer of the data from the first device to the second device may be performed independent of the host device. Furthermore, the method may include sending, by the first device, a data transfer completion message to the host device.

In conventional systems, when a data transfer session is initiated between a first device and a second device by a host device, the data is first transferred over the bus from the first device to the host device. The data is then temporarily cached at the host device before being transmitted over the bus to the second device. The host device transfers the data to the second device where the data is read from the bus and is stored. Also, when a large amount of data is transferred between the first device and the second device, the data will be temporarily cached at the host device before being transferred to the second device, thereby degrading performance of the host device.

In contrast to conventional systems, embodiments of the inventive concept provide a system and method that independently transfers the data from a first device to a second device without intervention of a host device. That is, the data is transferred from the first device to the second device without being transferred to the host device. Since the data is not transferred to the host device and is not temporarily cached at the host device, resource usage by the host device can be reduced, thus, improving performance of the host device and overall system throughput.

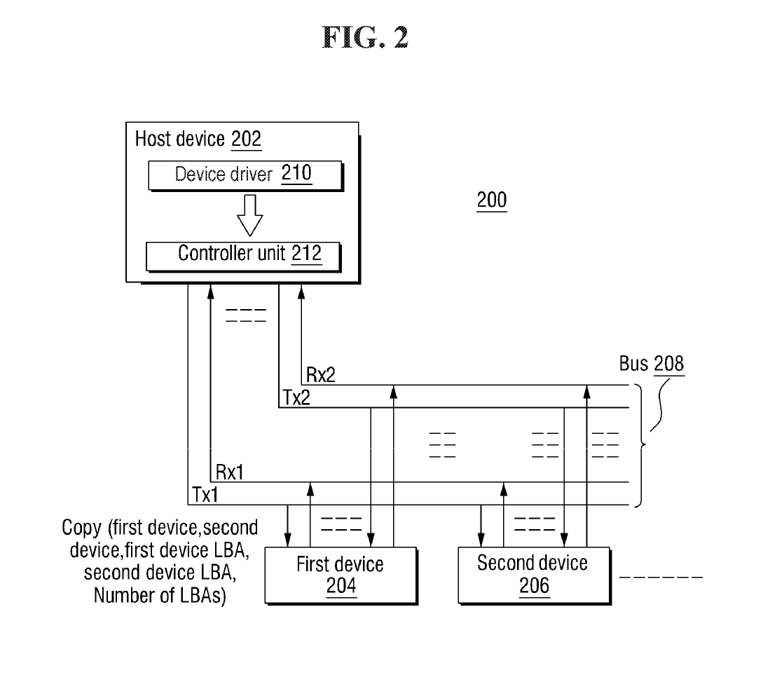

In the various embodiments of the inventive concept described with respect to FIGS. 2-6 as follows, the storage devices acting as slave devices are connected with each other through a bus to a host device acting as a master device. The data may be transferred directly from one storage device to another storage device independent of the host device, that is without being transferred to the host device. However, one of ordinary skill in the art will appreciate that the detailed description given herein with respect to FIGS. 2-6 is for explanatory purposes and can be extended to other embodiments.

Further, in embodiments of the inventive concept the storage devices may be non-volatile storage devices or volatile storage devices. The non-volatile storage devices may be flash, EEPROM based storage devices, or the like. The storage devices may be a removable or non-removable device. The non-removable devices are not envisioned for subsequent removal from the bus once they have been connected with the bus, whereas the removable devices are configured so as to be readily removed or added to the bus.

In embodiments of the inventive concept, the removable device may be a memory card/SSD for example, but is not limited thereto. The memory card is generally used to store digital data for use with various electronic devices. The memory card may be embedded or removable from the host device so that the stored data is portable. Such memory cards have a relatively small form factor and may be used to store digital data for various electronic devices including computers, hand-held computing devices, cellular telephones, media players or recorders such as MP3 devices, personal digital assistants (PDAs), network cards, network appliances, and other hand-held or embedded devices.

Further, the storage device may be compatible with a Multi Media Card (MMC) memory card format, a compact flash (CF) memory card format, a flash PC format such as an ATA Flash memory card format, a smart-media memory card format, or with any other industry standard specifications such as a peripheral component interconnect express (PCIe) based SSD like small computer system interface express (SCSIe) or non-volatile memory express (NVMe), serial AT attachment (SATA) SSD, universal flash storage (UFS) Memory Card, embedded multi-media card (eMMC), and dual in-line memory module (DIMM) memory. The storage device may also apply to other erasable programmable memory technologies, including but not-limited to electrically-erasable and programmable read-only memories (EEPROMs), EPROM, MRAM, FRAM ferroelectric and magnetic memories. The storage device configuration does not depend on the type of the removable memory, and may be implemented with any type of memory, whether flash memory or another type of memory.

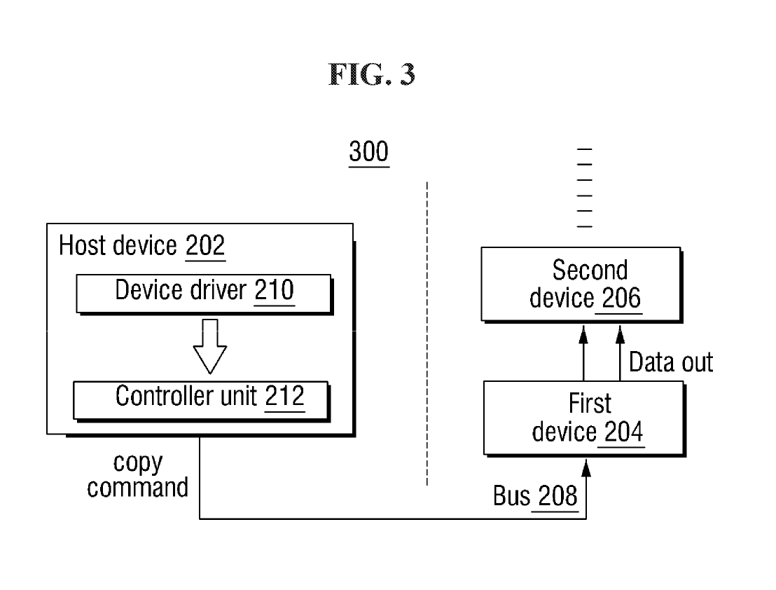

FIG. 2 is a block diagram illustrating a high level overview of a system 200 for transferring data from a first device 204 to a second device 206 without intervention of a host device 202, according to an embodiment of the inventive concept. In FIG. 2, the system 200 includes a plurality of control lines or data lines or address lines indicated as Tx1, Rx1 and Tx2, Rx2 (hereafter simply referred as a bus 208) which connect the host device 202 with the first device 204 and the second device 206. In other embodiments of the inventive concept, the first device 204 and the second device 206 may be arranged in a daisy chain configuration for transferring the data without intervention of the host device 202 (such as shown in the FIG. 3).

Further, the host device 202 includes a device driver 210 and a controller unit 212. In an embodiment, the actual number of control lines that constitute the bus 208 may also be widely varied. By way of example, some buses may have a relatively small number of control lines (e.g., 8-16 control lines), while other buses may have over 100 control lines that may themselves be logically divided into subsets of lines that effectively act as sub-buses (e.g., an address bus, a control bus, a data bus, or the like).

The host device 202 may be for example a computer, a laptop, a mobile phone or any other electronic device, but is not limited thereto. The first device 204 or the second device 206 may be a storage device. In an embodiment of the inventive concept, the storage device may be for example a conventional removable FLASH memory card or any of the aforementioned storage devices described above, but is not limited thereto.

In an embodiment of the inventive concept, the first device 204 and the second device 206 device include a corresponding unique and permanent device identifier. In some bus protocols, the permanent device identifier is used to identify a device e.g., first device 204 or second device 206) in the bus communications. In other protocols, the host device 202 may assign a temporary device identifier or an associated set of addresses to the first device 204 and the second device 206 coupled to the bus 208. Such temporary device identifiers or addresses may be assigned upon connection and initialization of the first device 204 and the second device 206 with the bus 208 and the host device 202, or in the case of a removable memory card, upon insertion of the card into an associated card reader. Although the bus protocol and the memory management protocol may vary based on the nature of the bus and the devices employed, the host device 202 may be aware of the respective device identifiers of each device.

In an embodiment of the inventive concept, the host device 202 initiates a session for transferring the data from the first device 204 to the second device 206 over the bus 208. Upon initiating the data transferring session, the device driver 210 is configured to issue the command to the controller unit 212. The command may be for example a copy command or a move command, but is not limited thereto. The command includes the address of the first device 204, the address of the second device 206, a logical block address (LBA) in the first device 204, a LBA in the second device 206, and the number of LBAs to be transferred from the first device 204 to the second device 206. Further, the command may include discontinuous fragment information of the logical object. Further, along with the command, the information of discontinues physical blocks may be sent to the bus 208 so that the first device 204 can transfer the data to the second device 206 without intervention of the host device 202.

Further, upon receiving the command, the controller unit 212 is configured to issue the command to the bus 208. The first device 204 and the second device 206 are configured to decode the command to initiate transfer of the data from the first device 204 to the second device 206. During the execution of the command, the first device 204 and the second device 206 do not require any intervention of the host device 202. After decoding, the command instructs the first device 204 to read the data from the storage unit (not shown) and to transfer the data onto the bus 208. The first device 204 may be configured to inform the host device 202 through a control line (not shown) of the bus 208 or through a message that the first device 204 is using the bus 208 partially or fully to transfer the data.

Further, the second device 206 is configured to prepare buffer or logical blocks within second device 206 after identifying that it may receive data from the first device 204. During the process of sending the data to the bus 208 by the first device 204, the second device 206 waits for the data to be received from the first device 204. Once the data is transferred by the first device 204 to the bus 208, the second device 206 receives the data. The second device 206 may be configured to send a notification message after receiving the complete data. Upon receiving the notification message, the first device 204 may be configured to send the data transfer completion message to the host device 202, thus informing the host device 202 that the bus 208 is free.

Unlike conventional systems, the first device 204 in system 200 as described with respect to FIG. 2 receives a copy command from the host device 202. Upon receiving the copy command, the data is copied onto the bus 208 and to the second device 206 without using any resources such as a Central Processing Unit (CPU), memory, or the like within the host device 202.

FIG. 3 is a block diagram illustrating a system 300 for transferring the data from the first device 204 to the second device 206 arranged in a daisy chain configuration, without intervention of the host device 202, according to an embodiment of the inventive concept. In FIG. 3, the system 300 includes similar components denoted by the same reference numerals as shown in FIG. 2, and detailed description of such similar components may be hereafter omitted for the sake of brevity. In FIG. 3, the system 300 includes the first device 204 and the second device 206 connected serially in a daisy chain arrangement. Such an arrangement may be desirable in various high speed electronics applications among others.

In an embodiment of the inventive concept as shown in FIG. 3, there is no common bus connecting the first device 204 and the second device 206 with each other and to the host device 202. In such a daisy chain configuration, each device passes the commands from the host device 202 to the next device downstream in the chain. The commands or the information passed from the host device 202 to the second device 206 first pass sequentially through the first device 204 in the chain. The first device 204 and the second device 206 along with the chain form a virtual communication bus serving to pass commands from the host device 202 to the first device 204 and the second device 206.

Although the first device 204 and the second device 206 are shown in the FIGS. 2 and 3, more or fewer devices can readily be coupled to the bus 208 and the data can be transferred without intervention by host device 202 and without departing from the scope of the inventive concept.

The inventive concepts should not be limited to the embodiments described with respect to the systems 200 and 300 in FIGS. 2 and 3. Further, the system 200 and the system 300 may include any number of host devices or units, along with other hardware or software components communicating with each other. For example, a component may be a process running in a controller or a processor, an object, an executable process, a thread of execution, a program, or a computer. By way of illustration, both an application running on a device and the device itself may be a component.

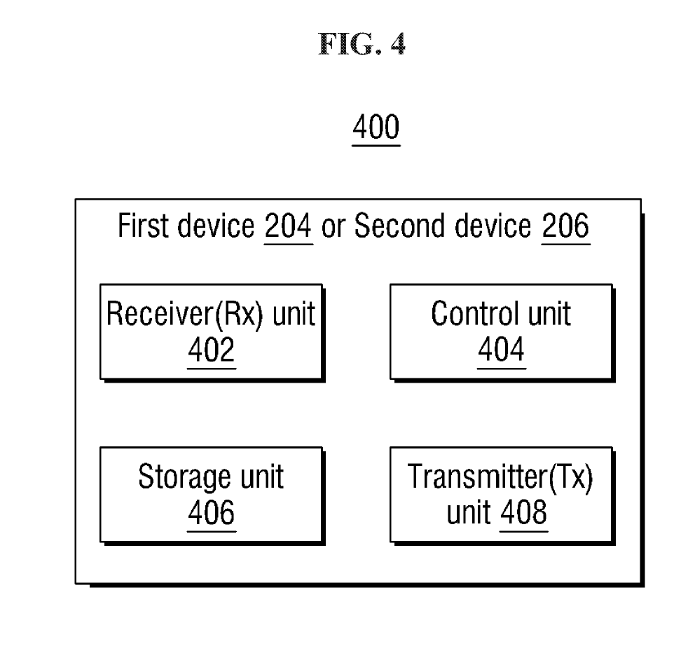

FIG. 4 is a block diagram illustrating various modules 400 of the first device 204 and/or the second device 206 of FIGS. 2 and 3, according to an embodiment of the inventive disclosure. In FIG. 4, the first device 204 or the second device 206 includes a receiver (Rx) unit 402, a control unit 404, a storage unit 406, and a transmitter (Tx) unit 408.

In an embodiment of the inventive concept, the Rx unit 402 in FIG. 4 is configured to receive the command from the host device 202 to transfer the data over the bus 208. Upon receiving the command, the Rx unit 402 is configured to send the command to the control unit 404. The control unit 404 is configured to decode the command.

In an embodiment of the inventive concept, after decoding the command, the control unit 404 is configured to read the data from the storage unit 406. In other embodiments of the inventive concept, after decoding the command, the control unit 404 is configured to allocate the buffer or the logical blocks in the storage unit 406. The storage unit 406 stores the control instructions and operations which are used to perform various operations described herein.

In an embodiment of the inventive concept, the Tx unit 408 transfers the data read from the storage unit 406 out to the bus 208. Further, the Tx unit 408 can be configured to inform the host device 202 through the control line or through the message that the corresponding first device 204 or the second device 206 is using the bus 208 partially or fully to transfer the data.

In other embodiments of the inventive concept, the Rx unit 402 receives the data over the bus 208. Upon receiving the data, the control unit 404 is configured to write the data to the allocated logical blocks in the storage unit 406. After writing the data completely onto the logical blocks, the Tx unit 408 can be configured to send a data receive completion message. Further, the Tx unit 408 can be configured to send a data transfer completion message to the host device 202.

The inventive concepts should not be limited to the embodiments described with respect to the various modules 400 of the first device 204 or the second device 206 shown in FIG. 4. Further, the first device 204 or the second device 206 may include any number of units communicating among each other along with the other components of the system 200.

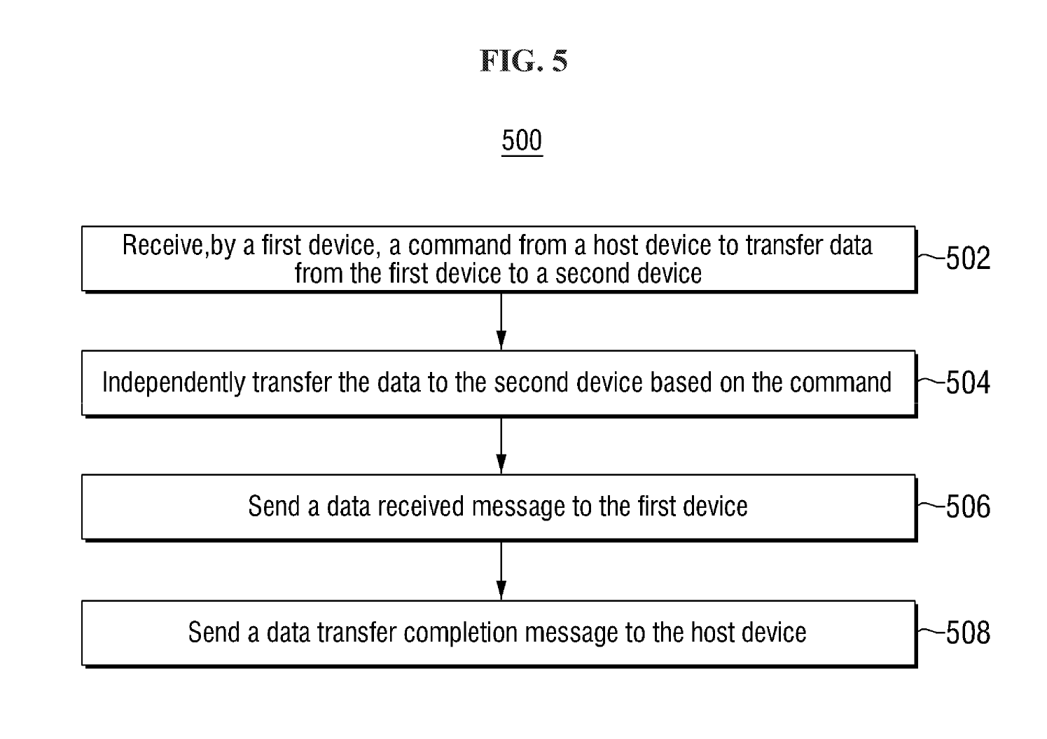

FIG. 5 is a flow diagram illustrating a method 500 for transferring data from a first device to a second device without intervention of a host device, according to an embodiment of the inventive concept. At step 502, the method 500 includes receiving the command, by or at the first device 204, to transfer the data from the first device 204 to the second device 206. The method 500 enables the host device 202 to send the command to the first device 204 to transfer data to the second device 206. In an embodiment of the inventive concept, the command is a copy command or the move command, and the command includes discontinuous fragment information of the logical object. The command includes the address of the first device 204, the address of the second device 206, a logical block address (LBA) in the first device 204, a LBA in the second device 206, and the number of LBAs to be transferred from the first device 204 to the second device 206.

At step 504, the method 500 includes independently transferring the data to the second device 206 based on the command. Unlike conventional systems, the method 500 of embodiments of the inventive concept enables the first device 204 to independently transfer the data to the second device 206 based on the command, without the intervention of the host device 202. The transfer of the data from the first device 204 to the second device 206 is performed independent of the host device 202. That is, the first device 204 may transfer the data to the second device 206 via the bus, without transferring the data to the host device 202.

At step 506, the method 500 includes sending a data received message from the second device 206 to the first device 204. The method 500 enables the second device 206 to send the data received message to the first device 204. At step 508, the method 500 includes sending a data transfer completion message to the host device 202. The method 500 enables the first device 204 to send the data transfer completion message to the host device 202.

The various actions, acts, blocks, steps, and the like in method 500 as shown in FIG. 5 may be performed in the order presented, in a different order or simultaneously. Further, in other embodiments of the inventive concept, some actions, acts, blocks, steps, and the like may be omitted, added, modified, skipped, and the like without departing from the scope of the inventive concept. For example, in an embodiment of the inventive concept steps 506 and 508 as show in FIG. 5 may be omitted.

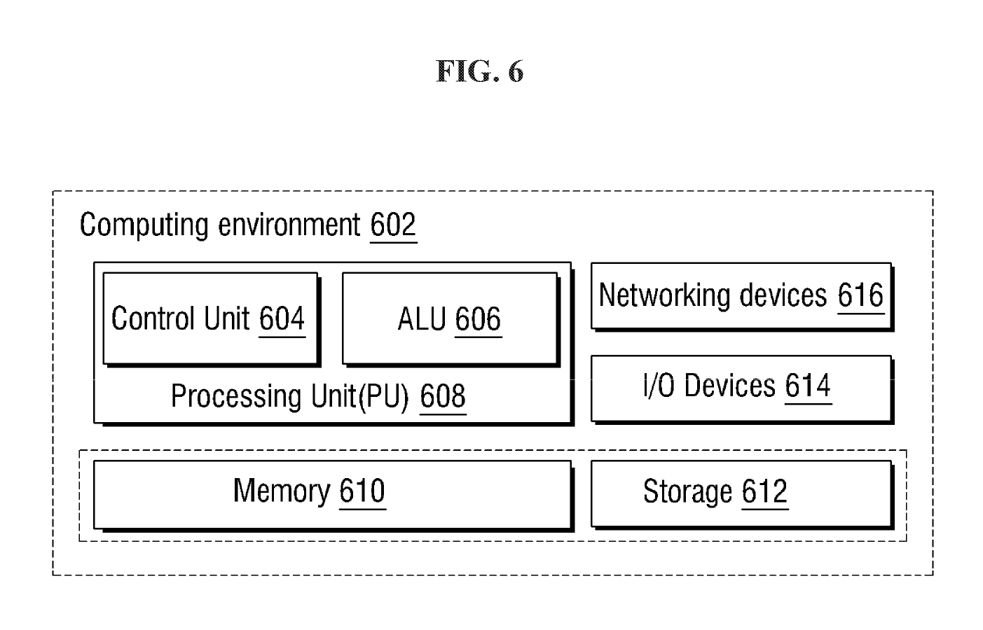

FIG. 6 is a block diagram illustrating a computing environment 602 implementing the method and system for transferring data from a first device to a second device over a plurality of control lines, according to an embodiment of the inventive concept. As depicted in the FIG. 6, the computing environment 602 includes at least one processing unit (PU) 608 that is equipped with a control unit 604 and an Arithmetic Logic Unit (ALU) 606, a memory 610, a storage unit 612, plurality of networking devices 616 and a plurality of input output (I/O) devices 614. The at least one processing unit 608 is responsible for processing the instructions of an algorithm. The at least one processing unit 608 receives commands from the control unit 604 in order to perform processing. Further, any logical and arithmetic operations involved in the execution of the instructions are computed with the help of the ALU 606.

The overall computing environment 602 may be composed of multiple homogeneous and/or heterogeneous cores, multiple CPUs of different kinds, special media and other accelerators. The at least one processing unit 608 is responsible for processing the instructions of the algorithm. Further, the at least one processing unit 608 may be located on a single chip or over multiple chips.

The algorithm including instructions and codes required for the implementation are stored in either the memory unit 610 or the storage 612, or both. At the time of execution, the instructions may be fetched from the corresponding memory 610 and/or storage 612, and executed by the at least one processing unit 608.

In case of any hardware implementations, various networking devices 616 or external I/O devices 614 may be connected to the computing environment 602 to support the implementation through the networking devices 616 and the I/O devices 614.

The embodiments disclosed herein can be implemented through at least one software program running on at least one hardware device and performing network management functions to control the elements. The elements shown in the FIGS. 2 through 6 include blocks which can be at least one of a hardware device, or a combination of hardware device and software module.

The inventive concept has been described with reference to specific example embodiments. It will however be evident that various modifications and changes may be made to the embodiments without departing from the broader spirit and scope of the inventive concept. Furthermore, the various devices, modules, and the like described herein may be enabled and operated using hardware circuitry, for example complementary metal oxide semiconductor based logic circuitry, firmware, software and/or any combination of hardware, firmware, and/or software embodied in a machine readable medium.

What is claimed is:

1. A method for transferring data over a plurality of control lines, the method comprising:
receiving, by a first device, a command from a host device to transfer the data from the first device to a second device; and
independently transferring, by the first device, the data to the second device based on the command,
wherein the data is independently transferred using the plurality of control lines and the transfer of the data from the first device to the second device is performed independent of the host device.

2. The method of claim 1, further comprising sending, by the first device, a data transfer completion message to the host device after the data is transferred to the second device.

3. The method of claim 1, wherein the plurality of control lines form a bus.

4. The method of claim 1, wherein the command is one of a copy command and a move command, and comprises discontinuous fragment information of a logical object.

5. The method of claim 1, wherein the command instructs the first device to write the data to the second device.

6. The method of claim 1, further comprising sending, by the second device, a data received message to the first device after the data has been received from the first device.

7. The method of claim 1, wherein the command comprises an address of the first device, an address of the second device, a logical block address in the first device, a logical block address in the second device, and a number of logical blocks to be transferred from the first device to the second device.

8. A system for transferring data over a plurality of control lines, the system comprises a first device and a second device coupled with each other and with a host device using at least one of the plurality of control lines, the system configured to:
receive, by the first device, a command from the host device to transfer the data from the first device to the second device; and
independently transfer, by the first device, the data to the second device based on the command,
wherein the data is independently transferred using the at least one of the plurality of control lines and the transfer of the data from the first device to the second device is performed independent of the host device.

9. The system of claim 8, further configured to send, by the first device, a data transfer completion message to the host computer.

10. The system of claim 8, wherein the plurality of control lines form a bus.

11. The system of claim 8, wherein the command is one of a copy command and a move command, and comprises discontinuous fragment information of a logical object.

12. The system of claim 8, wherein the command instructs the first device to write the data to the second device.

13. The system of claim 8, wherein the first and second devices comprise storage devices configured to be removably connectable to the at least one of the plurality of control lines.

14. A method of transferring data in a system including a host device interconnected with a plurality of devices by a bus, the method comprising:
transmitting a command from the host device to a first device from among the plurality of devices, the command comprising an instruction to transfer data from the first device to a second device from among the plurality of devices; and
responsive to the command, transferring the data from the first device to the second device via the bus without transferring the data to the host device.

15. The method of claim 14, further comprising:
sending a data received message from the second device to the first device after the data has been received from the first device; and
sending a data transfer completion message from the first device to the host device after the data received message is received at the first device.

16. The method of claim 14, wherein the command comprises an address of the first device, an address of the second device, a logical block address in the first device, a logical block address in the second device, and a number of logical blocks to be transferred from the first device to the second device.

17. The method of claim 14, wherein the plurality of devices are arranged in a daisy-chain configuration.

18. The method of claim 14, wherein the command is one of a copy command and a move command, and comprises discontinuous fragment information of a logical object.
